(19) United States
(12) Patent Application Publication
(10) Pub. No.: US 2025/0286684 A1
(43) Pub. Date: Sep. 11, 2025

(54) DETERMINING PATHLOSS REFERENCE SIGNALS FOR CELL ACTIVATION IN TELECOMMUNICATION SYSTEMS

(71) Applicant: Nokia Technologies Oy, Espoo (FI)

(72) Inventors: Lei DU, Beijing (CN); Lars DALSGAARD, Oulu (FI); Daejung YOON, Nozay (FR); Karri Markus RANTA-AHO, Espoo (FI)

(21) Appl. No.: 18/859,966

(22) PCT Filed: Apr. 25, 2022
(86) PCT No.: PCT/CN2022/089043

§ 371 Date: Oct. 24, 2024

(51) Int. Cl. H04L 5/00; H04B 7/06; H04W 52/14; H04W 52/24

(52) U.S. Cl. CPC H04L 5/0051; H04B 7/06968; H04W 52/146; H04W 52/242

(57) ABSTRACT

Systems, methods, apparatuses, and computer program products for determining pathloss reference signals for cell activation and compensating receive beam gain are provided. For example, a method can include selecting at least one reference signal, such as a synchronization signal block, as a default pathloss reference signal. The method can also include determining uplink transmit power for transmission by a user equipment, for example of a valid channel state information report, on a secondary cell using the selected at least one reference signal as the default pathloss reference signal.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for determining pathloss reference signals for cell activation and compensating receive beam gain.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory including computer program code. The at least one memory and the computer program code can be configured to, with the at least one processor, cause the apparatus at least to select at least one reference signal as a default pathloss reference signal for secondary cell activation. The at least one memory and the computer program code can also be configured to, with the at least one processor, cause the apparatus at least to determine uplink transmit power for transmission by a user equipment on a secondary cell using the selected at least one reference signal as the default pathloss reference signal.

An embodiment may be directed to a method. The method can include selecting at least one reference signal as a default pathloss reference signal for secondary cell activation. The method can also include determining uplink transmit power for transmission by a user equipment on a secondary cell using the selected at least one reference signal as the default pathloss reference signal.

An embodiment may be directed to an apparatus. The apparatus can include means for selecting at least one reference signal as a default pathloss reference signal for secondary cell activation. The apparatus can also include means for determining uplink transmit power for transmission by a user equipment on a secondary cell using the selected at least one reference signal as the default pathloss reference signal.

### BRIEF DESCRIPTION OF THE DRAWINGS

For proper understanding of example embodiments, reference should be made to the accompanying drawings, wherein:

FIG. 1A illustrates extended secondary cell activation due to additional pathloss reference signal measurement in a known secondary cell;

FIG. 1B illustrates extended secondary cell activation due to additional pathloss reference signal measurement in an unknown secondary cell;

FIG. 2 illustrates receive beam gain offset between layer three and layer one measurement, according to certain example embodiments;

FIG. 3 illustrates reuse of reference signal received power measurement reference signal for pathloss measurements, according to certain example embodiments;

FIG. 4 illustrates a method according to certain example embodiments; and

FIG. 5 illustrates an example block diagram of a system, according to an example embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for determining pathloss reference signals for cell activation and compensating receive beam gain, is not intended to limit the scope of certain example embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain example embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain example embodiments relate to fifth generation (5G) new radio (NR). More particularly, certain example embodiments address how to determine the default pathloss reference signal (PL-RS) during physical uplink control channel (PUCCH) secondary cell (SCell) activation as well as during primary secondary cell (PSCell) activation.

As the PUCCH is configured on PUCCH SCell, a user equipment (UE) may need to activate additional uplink actions, as compared with activating a downlink-only SCell. A valid channel state information (CSI) report needs to be transmitted when activating an SCell as to indicate to the network the ending point of SCell activation. For PUCCH SCell the CSI report is to be reported on the PUCCH SCell (not the PCell) and for this the PUCCH transmit power needs to be determined.

Third generation partnership project (3GPP) technical specification (TS) 38.133, section 8.3.12 indicates that if a UE does not have a valid timing advance (TA) for transmitting on an PUCCH SCell, then UE is to be capable of performing downlink actions related to an SCell activation command no later than a specified slot.

The PL-RS may be based on layer 3 (L3) measurements for known SCells and layer 1 (L1) measurements for unknown SCells in frequency range 2 (FR2). Certain example embodiments address how to determine the PL-RS when activating a PUCCH SCell in order to minimize activation delay.

The UE may use a synchronization signal block (SSB) identified during the initial access as the downlink (DL) reference signal (RS)/SSB for pathloss estimation for PUSCH, including message 3 (MSG3), before any DL RS(s) is explicitly configured for path loss measurement. On the other hand, the UE may use the SSB identified during the initial access as the DL RS/SSB for pathloss estimation for PUCCH before any DL RS(s) is explicitly configured for path loss measurement. Such an approach may be suitable both for carrier aggregation (CA) and non-CA cases of initial access.

According to 3GPP TS 38.213, section 7.2.1, the UE can determine the PUCCH transmit power by calculating the downlink pathloss estimate PL_{b,f,c}(q_{d}) using RS resource index q_{d}. The specification elaborates how to identify the RS resource when pathlossReferenceRSs and/or PUCCH-SpatialRelationInfo are configured. More particularly, the PL-RS used to determine PUCCH transmit power can be based on the pathlossReferenceRSs and/or PUCCH-SpatialRelationInfo parameters if configured, or a default DL-RS is used if neither of them is provided.

If the same principle is applied to determine the PL-RS at PUCCH SCell activation in FR2, additional activation delay would be expected depending on if the determined PL-RS has been measured or maintained. In particular, if the PUCCH SCell is known, in that the UE has sent a valid L3-RSRP measurement report with SSB index, the UE may need additional time to measure the PL-RS if the PL-RS is not one of the SSB reported. For example, such delay may occur if CSI-RS is configured in pathlossReferenceRSs or PUCCH-SpatialRelationInfo, or if SSB is configured in in pathlossReferenceRSs or PUCCH-SpatialRelationInfo, but different from any SSB of the reported L3-RSRP measurement, or if multiple SSBs are configured in pathlossReferenceRSs or PUCCH-SpatialRelationInfo, but the same SSB of reported L3-RSRP measurement is not maintained.

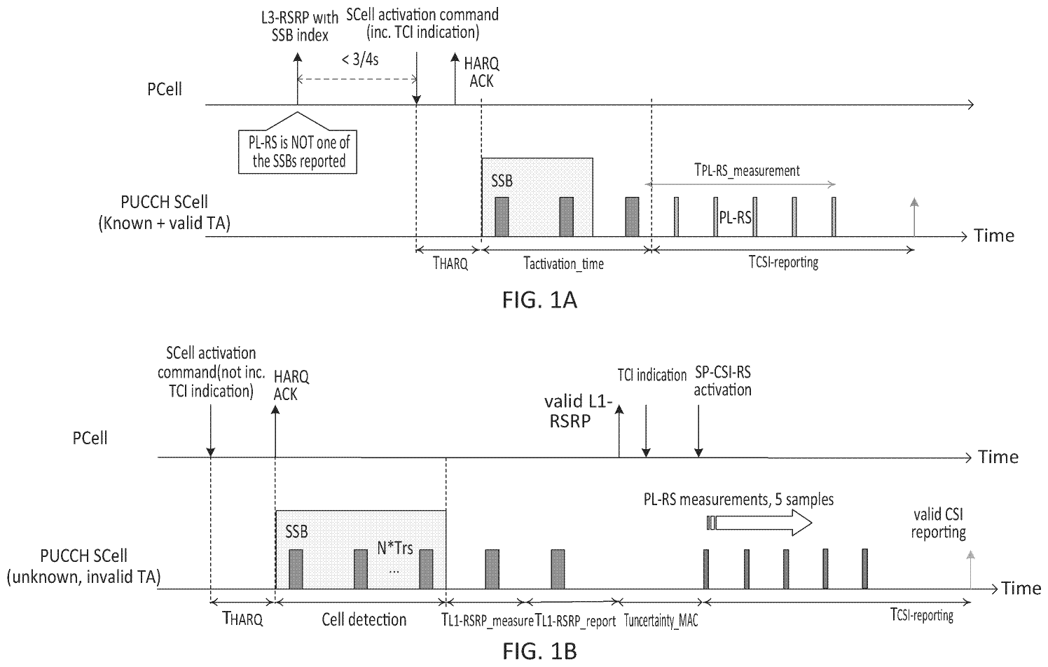

FIG. 1A illustrates extended SCell activation due to additional PL-RS measurement in a known SCell. In the example of FIG. 1A, as CSI-RS is configured as PL-RS for instance in pathlossReferenceRSs, the UE may need to measure five additional samples and thus incur additional delay before the path loss estimate is available. These five additional samples may be the T_{PL-RS_measurement} on the configured CSI-RS after SSB-based DL synchronization, in order to transmit a valid CSI report on PUCCH Scell.

FIG. 1B illustrates extended SCell activation due to additional PL-RS measurement in an unknown Scell. In the example of FIG. 1B, similarly to that of FIG. 1A, the UE may need additional time to measure the configured PL-RS after beam sweeping and after the network sends the transmission control indication (TCI) activation command. This may also extend the activation delay for PUCCH SCell.

Although PL-RS based on L3/L1 measurements is one approach, the additional PL-RS measurements may not really be needed for activating a SCell. Certain example embodiments, therefore, may provide a way to determine the PUCCH SCell transmit power and enable the PUCCH transmission for the first valid CSI report on PUCCH SCell as early as possible.

Certain example embodiments provide a way to determine and define a default PL-RS to be used at a PUCCH SCell activation to minimize the PUCCH SCell activation delay. For example, certain example embodiments may use available measurements results at the UE to avoid any need for additional PL-RS measurement and related measurement delay.

In one aspect, if the PUCCH SCell is known, the UE may use any of the following SSBs and/or CSI-RSs (other reference signals can also be used) as default PL-RS to determine the PUCCH transmit power for transmission of the valid CSI report on PUCCH SCell: the SSB that is QCL-ed with the activated TCI state, the SSB index of the SSB being one of the latest reported SSB indices; the SSB with the same index of any of the reported L3-RSRP measurements; the SSB associated with or QCL-ed with the configured CSI-RS, if CSI-RS has been configured as PL-RS, for example provided in pathlossReferenceRSs or PUCCH-SpatialRelationInfo; the SSB in the same TCI state as indicated in TCI activation command or uplink spatial relation activation command; or the SSB/CSI-RS associated or QCL-ed with the CSI-RS resources used for CSI reporting.

In another aspect, if the PUCCH SCell is unknown, the UE may use any of the following SSBs and/or CSI-RSs (other reference signals can also be used) as default PL-RS to determine the PUCCH transmit power for transmitting the valid CSI report on PUCCH SCell: the SSB that is QCL-ed with the activated TCI state for which the UE has performed L3 measurement; the SSB that is QCL-ed with the activated TCI state for which the UE has performed L3 measurement but not yet reported; the SSB/CSI-RS that has been reported in L1-RSRP measurement reporting and/or is maintained; the SSB in the same TCI state as indicated in TCI activation command or uplink spatial relation activation command; or the SSB/CSI-RS associated or QCL-ed with the CSI-RS resource used for CSI reporting.

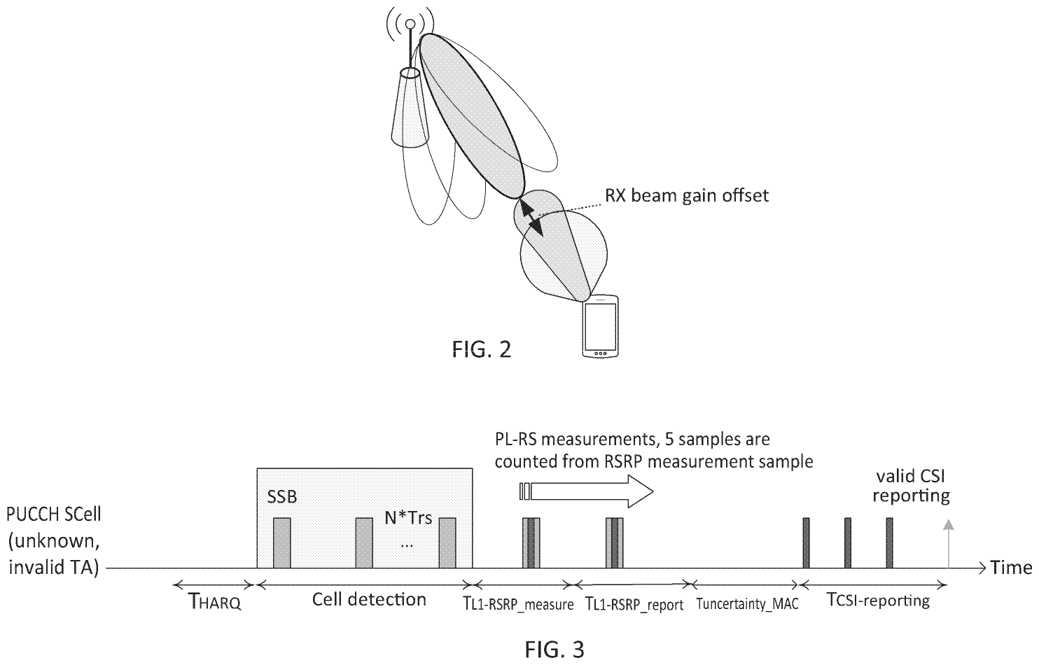

By defining the default RS as PL-RS, the UE may be able to reuse available L3/L1 measurement results to determine the PUCCH transmit power that may or may not be aligned with the PL-RS configuration. This may allow activation of a PUCCH SCell without additional PL-RS measurements and related delay. Accordingly, certain example embodiments may minimize the PUCCH SCell activation delay. Based on the proposed PL-RS selection, the path loss measurement period may be reduced by RX beam gain offset compensation between L3 measurement and L1 measurement, or between wide beam(s) and narrow beam(s) as discussed below at FIG. 2, and reuse of RSRP measurement reference signal for pathloss measurements, as discussed below at FIG. 3. UE behaviors mentioned above are also described at greater length below by way of non-limiting examples.

As mentioned above, candidate reference signals that can be used for path loss measurement are elaborated depending on cell known/unknown or L1/L3 measurement status. Certain example embodiments of PL-RS selection may depend on the measurement status, which may make UE behavior flexible to measure path loss RS for transmission (TX) power determination. There is no need that a UE strictly receive the exact reference signal configured as pathlossReferenceRS or PUCCH-SpatialRelationInfo for path loss measurement.

FIG. 2 illustrates receive (RX) beam gain offset between L3 and L1, according to certain example embodiments. When a UE is able to reuse already available L3 measurement results to determine the PUCCH transmit power, the UE may need a RX beam gain adjustment between L3 measurement and L1 measurement, and/or between wide beams and narrow beams for L3 measurements. Although the beam codebook design and selection are up to UE implementation, one approach may be that the RX spatial settings for data TX and RX beams are refined/narrow beams, while L3 measurement are measured using a beam which is a relatively wide/broad beam. If a UE performs PL-RS measurement using a broad beam, there may be a beam gain offset that can offset the measured quantity between measurements performed with refined and wide beams. For example, PUCCH TX beam can be a data TX beam that is a narrow beam. Accordingly, in such a case RX beam gain compensation on measured pathloss RS may be implemented.

Reference signal received power can be defined as a linear average over the power contributions of the resource elements that carry cell-specific reference signals within a considered measurement frequency bandwidth. The linear RX power can be expressed as Received Power (dBm)=Radiated Power/EIRP−Path Loss+RX Gain, where EIRP (dBm)=Radio Transmit Power (dBm)−Connector/Switch Loss (dB) at Transmitter+Transmit Antenna Gain (dBi), and where RX Gain=Receiver Antenna Gain (dBi)−Connector/Switch Loss (dB) at the receiver.

When determining PUCCH TX power, 3GPP TS 38.213 specifies the following equation:

$${P}_{PUCCH , b , f , c} ( i , {q}_{u} , {q}_{d} , 1 ) = min \{ \begin{matrix}{P}_{CMAX , f , c} ( i ) , \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , 1 )\end{matrix} \}$$

The details of each component of the preceding equation are specified in 3GPP TS 38.213. In this equation, however, only the path loss term, PL_{b,f,c}(q_{d}), is given from UE estimation, while the rest of parameters are pre-defined by high layer or pre-known. Given L3 and L1 measurements may result in different RSRP measurement results due to different Rx beam gain assumptions, such a difference may result in different path loss measurement results. However, it is not expected that this is physically different because of path loss difference itself, but due to UE RX gain differences. Path-loss is given from physical channel propagation. Path loss measurements may be affected by the fact that the receiver antenna gain may be designed differently between L1 and L3 measurement beams. Moreover, the number of paths captured in wide or narrow beams may be different in non line-of-sight (LoS) channel paths.

UE RX beam selection may be an issue in a frequency range 2 (FR2) UE case. A FR2 UE may work under mostly LoS channel conditions. Therefore, a UE can know the receiver antenna gain that is designed from UE implementation between L1 and L3 measurement beams and/or between wide beams and narrow beams, and such offset between L1 and L3 and/or between wide and narrow beams can be compensated.

In this sense, the RS samples used for the L1 or L3 RSRP measurements can be reused for pathloss measurement. For example, it is possible that the five samples of PL-RS can start to be counted from L1-RSRP samples.

Certain example embodiments provide receive beam compensation that the following equation can hold: PL_{b,f,c}(q_{d})=referenceSignalPower−higher layer filtered RSRP+RX beam gain offset, where RX beam gain offset can be pre-defined by the UE depend on the UE's capabilities. Note that this may be regarded as an approximate measurement method in terms of accuracy, but it may still be effective to reduce UL transmission latency. This compensation can be specified in a standard specification, or a UE may attempt this compensation by UE implementation. A UE may indicate if the UE supports the RX beam gain compensation in the UE's capability. With such capability indication, the UE is able to apply the compensation so that the existing L3 or L1 measurement results can be reused directly for pathloss estimation. This may be used for PUCCH SCell activation, and may also be used for other cases where UL transmit power needs to be determined.

FIG. 3 illustrates reuse of reference signal received power measurement reference signal for pathloss measurements, according to certain example embodiments. Reuse/use of already available RSRP reference signal measurements for pathloss measurements can serve as another way to reduce UL transmission latency due to path-loss measurement.

One reason to set up the UE behavior illustrated in FIG. 1 is that the baseline behavior assumes two different procedures of pathloss measurement: a first procedure in which PL-RS measurement beam selection is performed through L3 or L1-RSRP, and then a second procedure in which higher layer filtered RSRP is derived from five samples of PL-RS. However, if the two procedures are performed on the same reference signal as in certain example embodiments, the procedures do not need to be two separate procedures. Instead, certain example embodiments can combine procedures and obtain the filtered received power. Also, the UE can selectively use some measurement samples out of five samples for the filtering. In this way, the PL-RS measurement sample period can be shorten for PUCCH CSI reporting.

In certain example embodiments, measurement samples for the higher layer filtered RSRP in path loss measurement, PL_{b,f,c}(q_{d}), may include L1-RSRP measurement samples used for L1-beam search within T_{PL-RS_measurement}. The filtering can include selection of some samples, for example three samples out of five samples, and then averaging. Thus, certain example embodiments may provide behavior that can help to reduce UL transmission latency due to path-loss measurement.

Additionally, if the to-be-activated PUCCH SCell is known and UE therefore already has performed cell detection and measurements on the cell for one or more SSB Indexes, these measurements can be readily re-used for PL estimation for UL transmission. For example, if the SCell is known, has been measured and the results have been reported to the network, which is the condition for SCell being considered known, if the network then activates the SCell the UE can use the already performed measurements as PL estimate and can use such estimate for deriving the transmission power. In this case, no additional PL-RS measurement is needed.

Similar techniques can also apply if the to-be-activated PUCCH SCell is unknown. Even if the SCell is categorized as unknown, the UE may very well have valid and up to date DL measurements for the SCell for one or more SSBs which can be used as a base for deriving the DL PL estimate. For example, the UE may have reported the SCell including the SSB Index. During the time delay between the UE reporting the SCell and the SCell being activated, the SCell can be considered unknown. However, in many situations, the UE may not move significantly and UE may still perform DL PL measurements on the deactivated SCell. Thus, the UE may in most cases have DL PL estimate available for the PUCCH SCell once it is activated. These measurements can, just as in known SCell case, be re-used for PL estimate and used for deriving the transmission power. That is, if the SCell is unknown, the additional PL-RS measurement is not needed if the determined PL-RS has been measured in deactivated PUCCH SCell or if the determined PL-RS is maintained. Otherwise, if the determined PL-RS has not been measured in deactivated PUCCH SCell or it is not maintained, the UE may need additional PL-RS measurements to determine the transmit power, or may need to apply RX beam gain offset compensation to the available L1 measurement.

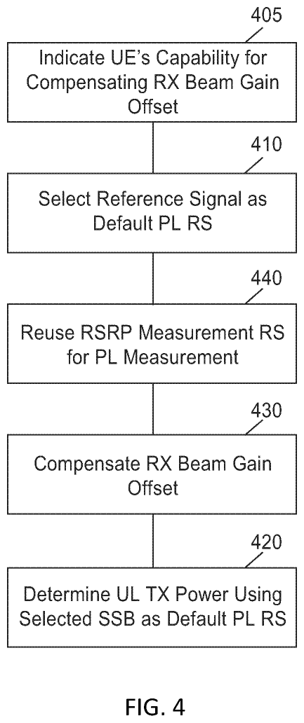

FIG. 4 illustrates an example flow diagram of a method for determining pathloss reference signals for cell activation and compensating receive beam gain, according to certain example embodiments. As shown in FIG. 4, a method can include, at 410, selecting at least one reference signal, such as a synchronization signal block or channel state information reference signal, as a default pathloss reference signal. The method can also include, at 420, determining uplink transmit power for transmission by a user equipment, for example of a valid channel state information report, on a secondary cell using the selected at least one reference signal as the default pathloss reference signal.

In certain cases, the secondary cell can be known. The criteria for being deemed known are discussed above. When the secondary cell is known, the at least one reference signal can be a reference signal that is quasi-colocated with an activated transmission control indication state. The reference signal can have an index that was included among reported indices, such as synchronization signal block indices. When the reference signal is known, the at least one reference signal can, as another alternative, include with a same index as the index of a reported layer three reference signal received power measurement. When the secondary cell is known, the at least one reference signal can, as yet another alternative, include a reference signal associated with or quasi-colocated with a configured channel state information reference signal, when the channel state information reference signal is configured as a pathloss reference signal, for example provided in pathlossReferenceRSs or PUCCH-SpatialRelationInfo. When the secondary cell is known, the at least one reference signal can, as still another alternative include a reference signal in a same transmission control indication state as indicated in a transmission control indication command or uplink spatial relation activation command. When the secondary cell is known, the at least one reference signal can be associated with or quasi-colocated with a channel state information reference signal resource used for channel state information reporting.

In certain cases, the secondary cell can be unknown. When the secondary cell is unknown, the at least one reference signal can be quasi-colocated with an activated transmission control indication state for which the user equipment has performed layer three measurement. Optionally, the user equipment may not yet have reported the reference signal and the reference signal may be configured as pathloss reference signal. When the secondary cell is unknown, the at least one reference signal can, as another alternative, include a channel state information reference signal or synchronization signal block that has been reported in a layer one reference signal received power measurement reporting or is maintained. When the secondary cell is unknown, the reference signal can, as a further alternative, include a reference signal in a same transmission control indication state as indicated in a transmission control indication command or uplink spatial relation activation command. When the secondary cell is unknown, the at least one reference signal can be associated with or quasi-colocated with a channel state information reference signal used for channel state information reporting.

The method can also include, at 430, compensating receive beam gain offset between layer three measurement and layer one measurement. This compensation may be performed as discussed above with reference to FIG. 2. The method can additionally include, at 405, indicating the user equipment's capability for compensating the receive beam gain offset. This indication can be provided by the UE to the network. The method can further include, at 440, reusing a reference signal received power measurement reference signal for pathloss measurements.

It is noted that FIG. 4 is provided as one example embodiment of a method or process. However, certain example embodiments are not limited to this example, and further examples are possible as discussed elsewhere herein.

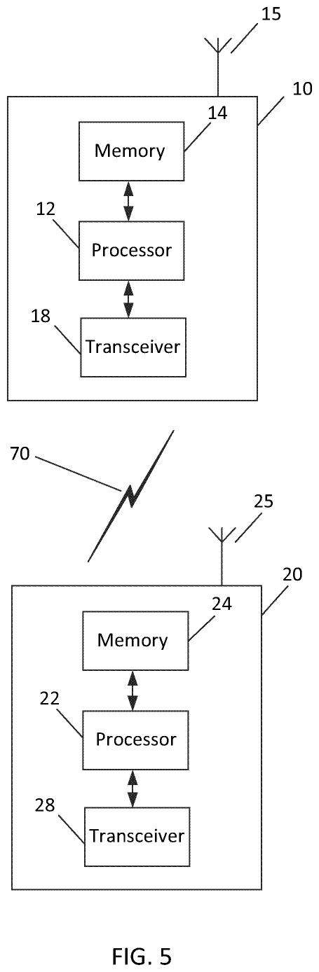

FIG. 5 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 5.

As illustrated in the example of FIG. 5, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 5, multiple processors may be utilized according to other embodiments. For example, it should be understood that, in certain example embodiments, apparatus 10 may include two or more processors that may form a multiprocessor system (e.g., in this case processor 12 may represent a multiprocessor) that may support multiprocessing. In certain example embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some example embodiments, apparatus 10 may include an input and/or output device (I/O device), or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and memory 14 may be included in or may form a part of processing circuitry/means or control circuitry/means. In addition, in some example embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain example embodiments, apparatus 10 may be controlled by memory 14 and processor 12 to perform the functions associated with any of the embodiments described herein. For example, in some example embodiments, apparatus 10 may be configured to perform one or more of the processes depicted in any of the flow charts or signaling diagrams described herein, such as those illustrated in FIGS. 2-4, or any other method described herein. In some example embodiments, as discussed herein, apparatus 10 may be configured to perform a procedure relating to determining pathloss reference signals for cell activation and compensating receive beam gain, for example.

FIG. 5 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some example embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5.

As illustrated in the example of FIG. 5, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some example embodiments, apparatus 20 may include an input and/or output device (I/O device). In certain example embodiments, apparatus 20 may further include a user interface, such as a graphical user interface or touchscreen.

In an example embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some example embodiments, processor 22 and memory 24 may be included in or may form a part of processing circuitry or control circuitry. In addition, in some example embodiments, transceiver 28 may be included in or may form a part of transceiving circuitry.

As discussed above, according to some example embodiments, apparatus 20 may be a UE, SL UE, relay UE, mobile device, mobile station, ME, IoT device and/or NB-IoT device, or the like, for example. According to certain example embodiments, apparatus 20 may be controlled by memory 24 and processor 22 to perform the functions associated with any of the embodiments described herein, such as one or more of the operations illustrated in, or described with respect to, FIGS. 2-4, or any other method described herein. For example, in an embodiment, apparatus 20 may be controlled to perform a process relating to determining pathloss reference signals for cell activation and compensating receive beam gain, as described in detail elsewhere herein.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain example embodiments have various benefits and/or advantages. For example, by defining the default RS as PL-RS, the UE may be able to reuse available L3 measurement results to determine the PUCCH transmit power that may or may not be aligned with the PL-RS configuration. This reuse may allow activation of a PUCCH SCell without additional PL-RS measurements and related delay. Thus, certain example embodiments may minimize the PUCCH SCell activation delay.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain example embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some example embodiments have been described based upon these example embodiments, it would be apparent to those of skill in the art that certain modifications, variations, and alternative constructions would be apparent, while remaining within the spirit and scope of example embodiments.

### PARTIAL GLOSSARY

CSI Channel-state information
CSI-RS Channel-State Information Reference Signals
FR1 Frequency range 1
FR2 Frequency range 2
NG-RAN New Generation-Radio Access Network
NW Network
PDCCH Physical Downlink Control Channel
RRC Radio resource control protocol
RRM Radio resource management
RSRP Reference Signal Received Power
RSRQ Reference Signal Received Quality
SINR Signal-to-Interference and noise ratio
SSB Synchronization Signal Block
TCI Transmission Control Indication
UE User Equipment

1. An apparatus, comprising:
at least one processor; and
at least one memory including computer program code,
wherein the at least one memory and the computer program code that, when executed by the at least one processor, cause the apparatus at least to:
select at least one reference signal as a default pathloss reference signal for secondary cell activation; and
determine uplink transmit power for transmission by a user equipment on a secondary cell using the selected at least one reference signal as the default pathloss reference signal.

2. The apparatus of claim 1, wherein the at least one reference signal is a synchronization signal block or a channel state information reference signal.

3. The apparatus of claim 1, wherein the secondary cell is known.

4. The apparatus of claim 3, wherein the at least one reference signal is quasi-colocated with an activated transmission control indication state, wherein an index of the reference signal was included among reported reference signal block indices.

5. The apparatus of claim 3, wherein the at least one reference signal has a same index as a reported layer three reference signal received power measurement.

6. The apparatus of claim 3, wherein the at least one reference signal comprises a synchronization signal block associated with or quasi-colocated with a configured channel state information reference signal, when the channel state information reference signal is configured as a pathloss reference signal.

7. The apparatus of claim 3, wherein the at least one reference signal comprises a reference signal in a same transmission control indication state as indicated in a transmission control indication command or uplink spatial relation activation command.

8. The apparatus of claim 3, wherein the at least one reference signal is associated with or quasi-colocated with a channel state information reference signal used for channel state information reporting.

9. The apparatus of claim 1, wherein the secondary cell is unknown.

10. The apparatus of claim 9, wherein the at least one reference signal is quasi-colocated with an activated transmission control indication state for which the user equipment has performed layer three measurement or the reference signal is maintained.

11. The apparatus of claim 10, wherein the user equipment has not yet reported the reference signal.

12. The apparatus of claim 9, wherein the at least one reference signal has been reported in a layer one reference signal received power measurement reporting.

13. The apparatus of claim 9, wherein the reference signal is in a same transmission control indication state as indicated in a transmission control indication command or uplink spatial relation activation command.

14. The apparatus of claim 9, wherein the reference signal is associated with or quasi-colocated with a channel state information reference signal used for channel state information reporting.

15. The apparatus of claim 1, wherein the at least one memory and the computer program code are configured to, with the at least one processor, cause the apparatus at least to compensate receive beam gain offset between layer three measurement and layer one measurement, or between wide beam and narrow beam.

16. The apparatus of claim 15, wherein the at least one memory and the computer program code are configured to, with the at least one processor, cause the apparatus at least to indicate the user equipment's capability for compensating the receive beam gain offset.

17. The apparatus of claim 1, wherein the at least one memory and the computer program code are configured to, with the at least one processor, cause the apparatus at least to reuse reference signal received power measurement reference signal for pathloss measurements.

18. A method for an apparatus, comprising:
selecting at least one reference signal as a default pathloss reference signal for secondary cell activation; and
determining uplink transmit power for transmission by a user equipment on a secondary cell using the selected at least one reference signal as the default pathloss reference signal.

19. The method of claim 18, wherein the at least one reference signal is a synchronization signal block or a channel state information reference signal.

20. (canceled)

21. The method of claim 18, wherein the at least one reference signal is quasi-colocated with an activated transmission control indication state, wherein an index of the reference signal was included among reported reference signal block indices.

22-53. (canceled)
